(19) United States
(12) Patent Application Publication
(10) Pub. No.: US 2007/0284504 A1
(43) Pub. Date: Dec. 13, 2007

(54) Arrow holder

(76) Inventor: Donavon Cross, Enid, OK (US)

Correspondence Address: US CORPORATIONS, INC., P.O. BOX 234265, ENCINITAS, CA, 92023, US

(21) Appl. No.: 11/450,954

(22) Filed: Jun. 10, 2006

(51) Int. Cl. F16M 13/02

(52) U.S. Cl. 248/511

(57) ABSTRACT

An arrow holder to include a support body having a generally flexible body of a size and shape to be readily held in the hand of the user and a flexible mounting strap for quick and easy attachment to any hard surface such as a tree limb or nail. The body includes means for receiving portions of an arrow and mounting device such as a limb, nail or screw.

### CROSS-REFERENCE TO RELATED APPLICATION

### STATEMENT REGARDING FEDERALLY SPONSORED RESEARCH OR DEVELOPMENT

Not applicable

### REFERENCE TO SEQUENCE LISTING

Not applicable

### BACKGROUND OF THE INVENTION

1. Field of the Invention

The invention relates generally to an arrow holder for quick and easy access during hunting.

2. Background of the Invention

Bow hunters and other archery enthusiasts have for many years had a variety of different bow-mounted arrow quivers available to them, which make it easier to carry extra arrows. This is particularly desirable for hunting purposes, while stalking or waiting in a blind for game, since such quivers are carried integrally with the bow and are thus immediately accessible for rapidly withdrawing additional arrows in the event fast second or third shots are necessary. A preferred such quiver device and field-mounting apparatus is proposed herein.

Many bow hunters use blinds which they have built from logs, branches, and other natural materials found in the woods, and many utilize elevated blinds, e.g., platforms or other such structures secured in trees at some position elevated above the ground. These are particularly advantageous since most game, in particular larger animals such as deer and the like, are not thought to be upwardly observant, largely concentrating their surveillance to a horizontal line of sight. Thus, although extremely wary by nature, game such as deer and the like are known to frequently walk directly beneath a hunter occupying an elevated blind, for example in a tree.

In either event, and regardless of whether or not the hunter's blind is elevated, most hunters would prefer to have their bows unencumbered by quivers and spare arrows were it not for the desirability of having extra arrows immediately available in the shortest possible time. Accordingly, hunters who use blinds frequently wish to remove their bow-mounted quivers and to fasten them in some manner at a relatively convenient position upon some part of the blind which they are occupying. In order to accomplish this goal, hunters have resorted to many different forms of mounting means for their quivers, often securing them to or hanging them upon some part of the blind itself, e.g., tree branches, etc. Of course, it is not surprising that such rudimentary devices usually provide less than complete satisfaction, since they are likely to be makeshift in nature and are frequently laborious or tedious to fashion or implement, particularly under actual hunting circumstances and conditions in which inclement weather, low temperatures and the like are often present.

At times, such efforts to mount the hunter's quiver upon some part of the hunting blind is done in such a rudimentary manner that the quiver is not at all secure and will inadvertently loosen and fall to the ground, particularly during the excitement of shooting at game, which is, of course, the time when it is most inconvenient. At other times, as where a hunter has a favorite and frequently-used blind or stand, a more permanent securement will be utilized, e.g., screws or nails, which normally result in a semi-permanent installation. Of course, this requires that the hunter either leave his mounting brackets, etc., in position at all times, during the long intervals when hunting is not actually taking place, or else carry the necessary tools and equipment into the woods each time he goes to the blind, which is obviously cumbersome, laborious and generally undesirable.

### SUMMARY OF THE INVENTION

The present invention provides a novel and useful solution to the foregoing problem, in the form of a simple yet durable and readily-usable apparatus which the hunter can easily carry in his pocket and readily install at a blind or stand, regardless of weather conditions and the like. Furthermore, the novel apparatus in accordance with the invention provides a readily-detachable quick-disconnect mount for an arrow utilizing a mounting device which may be left in place if desired, whether for only a brief interval or for a longer period of time, during which the hunter may mount and dismount his quiver in a simple and rapid manner while hunting from the same blind over a period of several days. Furthermore, the novel device in accordance herewith is readily detachable in a simple and effective manner, and may easily be carried from the field when hunting is over.

Accordingly, a major object and advantage of the invention is to provide a field mount for a single arrow which is of simplified structure and of paratively few parts, which may be easily carried to the blind or stand, and which is readily and rapidly installed, as well as removed, at the blind or stand where hunting is to take place. In addition, the field mount of the invention provides integral, self-contained means for mounting it upon trees and the like, so that no additional tools need be brought into the field to weigh down the hunter's coat and make subsequent hunting actions cumbersome or inconvenient. In addition, the apparatus in accordance herewith is extremely durable and comparatively inexpensive in nature and structure, to further facilitate its manufacture and use.

Summarily stated, the field mount arrow holder in accordance with the invention comprises an attachment strap, a body being generally flexible and of elongated and flat configuration, which is adapted to carried upon the person, in pockets and the like. The apparatus further includes a hole on both ends. One hole larger than the other. The larger of the two holes will allow the entrance of the female end of an arrow with enough tension to conquer the gravitational pull of its weight. The opposing end of the device embodies a smaller hole for the purpose of hanging on a nail, screw or similar.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and. scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide an arrow holder device which has many of the advantages of the carts mentioned heretofore and many novel features that result in an arrow holder device which is not anticipated, rendered obvious, suggested, or even implied by any of the prior art tool guides, either alone or in any combination thereof.

It is another object of the present invention to provide an arrow holder device which may be easily and efficiently manufactured and marketed.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The foregoing major objects and advantages of the invention will be further understood by reference to the attached drawings depicting a preferred embodiment of the invention, in which:

FIG. 1 is a pictorialized front elevational view showing the arrow holder without an arrow inserted, showing the attachment strap hanging from one hole;

FIG. 2 is a front elevational view of the arrow holder, shown in FIG. 1, holding an arrow and bent as if temporarily mounted on a solid surface such as a tree.

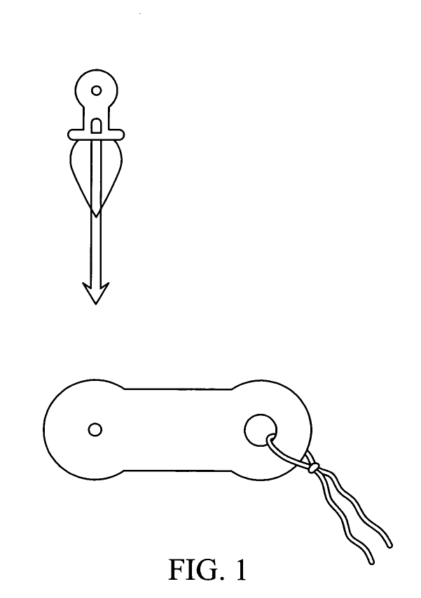

### DETAILED DESCRIPTION OF THE PREFERRED EMBODIMENTS

While I have shown but a few embodiments of the invention, it will be apparent to those skilled in the art that the invention may be embodied still otherwise without departing from the spirit and scope of the invention.

The embodiments of the invention in which an exclusive property or privilege is claimed are defined as follows:

1. A portable and detachable, arrow holder, comprising in combination: platform base having a generally flexible body of elongated configuration and of a size and shape adapted to be held in the human hand; a flexible string type attachment member carried by said body; said body including two holes; said first hole for temporary attachment to a hunting arrow; said second hole for temporary attachment to a solid surface.

2. An arrow holder according to claim 1, and further including a strap attachment connected to either of the access holes.

3. An arrow holder according to claim 1, wherein said strap attachment member is removably carried by said body.

4. An arrow holder according to claim 1, wherein the device maintains a shape conductive to adequate flexibility and support when mounted and containing the arrow.

5. An arrow holder according to claim 1, wherein the device maintains a shape conductive to adequate flexibility and support when mounted and containing the
